(19) United States
(12) Patent Application Publication
(10) Pub. No.: US 2023/0146008 A1
(43) Pub. Date: May 11, 2023

(54) Orthodontic Arch Wires & Methods of Use for Prevention of Flaring of Anterior Teeth During Alignment

(71) Applicant: Ravikumar R. Anthony, San Antonio, TX (US)

(72) Inventor: Ravikumar R. Anthony, San Antonio, TX (US)

(21) Appl. No.: 17/013,502

(22) Filed: Sep. 4, 2020

Related U.S. Application Data
(60) Provisional application No. 63/030,345, filed on May 27, 2020.

(51) Int. Cl. A61C 7/30

(52) U.S. Cl. CPC A61C 7/303; A61C 2201/00

(57) ABSTRACT

Orthodontic arch wires with specific shapes and bends designed to encourage expansion of the posterior teeth while preventing the flaring of anterior teeth during the alignment phase. The arch wires divide the dentition into sections and treat each section differently so as to minimize undesirable effects during the alignment process. While the arch wires of the present invention are used to improve mechanics with non-extraction, they can also be used in extraction cases to avoid round tripping and some iatrogenic side effects that can occur by engaging all the teeth at the same time. The arch wires of the present invention can be preformed or customized to each case. The arch wires of the present invention are generally of two types referred to as sectional (S-RA) wires and consolidation (C-RA) wires.

### CROSS REFERENCES TO RELATED APPLICATIONS

This application claims the benefit under Title 35 United States Code § 119(e) of U.S. Provisional Patent Application Ser. No. 63/030,345; Filed: May 27, 2020; the full disclosure of which is incorporated herein by reference.

### BACKGROUND OF THE INVENTION

### 1. Field of the Invention

The present invention relates generally to orthodontic arch wires and the use of the same to facilitate the alignment of teeth. The present invention relates more specifically to orthodontic arch wires and methods for use of the same to achieve dental treatment objectives with minimal side effects (such as flaring of anterior teeth).

### 2. Description of the Related Art

The present invention addresses some of the problems associated with existing arch wires and methods of use that frequently result in undesirable side effects during the alignment process. Such undesirable side effects include, but are not limited to, the flaring of anterior teeth during the alignment process.

### SUMMARY OF THE INVENTION

The present invention provides arch wires (referred to hereinbelow as RA arches) that are orthodontic arch wires with specific shapes and bends designed to encourage expansion of the posterior teeth while preventing the flaring of anterior teeth during the alignment phase. The arch wires of the present invention divide the dentition into sections and treat each section differently so as to minimize undesirable effects during the alignment process. While the arch wires of the present invention are used to improve mechanics with non-extraction, they can also be used in extraction cases to avoid round tripping and some iatrogenic side effects that can occur by engaging all the teeth at the same time. The arch wires of the present invention can be preformed or customized to each case. The arch wires of the present invention are generally of two types, hereinbelow referred to as S-RA arches and C-RA arches.

### BRIEF DESCRIPTION OF THE DRAWINGS

FIG. 1A is a perspective view of a preferred embodiment of the basic orthodontic arch wire of the present invention showing the defined regions of the arch wire.

FIG. 1B is a top plan view of the preferred embodiment of the basic orthodontic arch wire shown in FIG. 1A showing the defined regions of the arch wire and the anterior section “radius step” element of the present invention.

FIG. 1C is a front elevational view of the preferred embodiment of the basic orthodontic arch wire shown in FIG. 1A showing the defined regions of the arch wire and the optional anterior section “vertical step” element of the present invention.

FIG. 1D is a side elevational view of the preferred embodiment of the basic orthodontic arch wire shown in FIG. 1A showing the defined regions of the arch wire and the optional anterior section “vertical step” element of the present invention.

FIG. 1E is a three dimensional view of the bend of one of the lateral sections of the preferred embodiment of the basic orthodontic arch wire shown in FIG. 1A showing the anterior section “radius step” element and the optional anterior section “vertical step” element of the present invention.

FIG. 2A is a plan view (looking downward) of an example of the preferred embodiment of the basic orthodontic arch wire of the present invention shown in place on a mandibular (lower) set of teeth.

FIG. 2B is a plan view (looking upward) of an example of the preferred embodiment of the basic orthodontic arch wire of the present invention shown in place on a maxillary (upper) set of teeth.

FIG. 3A is a top plan partial view (looking downward) of an example of the preferred embodiment of the orthodontic arch wire of the present invention shown in place on a mandibular (lower) set of teeth, configured with symmetrical lateral wings.

FIG. 3B is a top plan partial view (looking downward) of an example of the preferred embodiment of the orthodontic arch wire of the present invention shown in place on a mandibular (lower) set of teeth, configured with asymmetrical wings (one lateral wing and one mesial wing).

FIG. 3C is a top plan partial view (looking downward) of an example of the preferred embodiment of the orthodontic arch wire of the present invention shown in place on a mandibular (lower) set of teeth, configured with reversed asymmetrical wings (one lateral wing and one mesial wing).

FIG. 3D is a top plan partial view (looking downward) of an example of the preferred embodiment of the orthodontic arch wire of the present invention shown in place on a mandibular (lower) set of teeth, configured with symmetrical mesial wings.

FIG. 4 is a plan view (looking downward) of an example of a customization of the preferred embodiment of the basic orthodontic arch wire of the present invention shown in place on a mandibular (lower) set of teeth.

FIG. 5 is a flowchart of the basic method steps associated with the general approach to treatment implementing the system and methods of the present invention.

FIGS. 6A & 6B are flowcharts of the methods steps associated with a first example of the implementation of the system and methods of the present invention.

FIGS. 7A-7P are front profile and top plan views of summary examples of categories of lower arches according to the present invention.

FIGS. 8A-8F are front profile and top plan views of summary examples of categories of upper arches according to the present invention.

### DETAILED DESCRIPTION OF THE PREFERRED EMBODIMENTS

The arch wires of the present invention (referred to hereinbelow as RA arches) are orthodontic arch wires with specific shape and bends to primarily encourage expansion of the posterior teeth while preventing the flaring of anterior teeth during the alignment phase. The arch wires of the present invention divide the dentition into sections and treats them differentially. While the arch wires of the present invention are used to improve mechanics with non-extraction, they can also be used in extraction cases to avoid round tripping and some iatrogenic side effects that can happen by engaging all the teeth at the same time.

The arch wires of the present invention can be preformed or customized to each case. The arch wires of the present invention are of two types, hereinbelow referred to as S-RA arches and C-RA arches. In the methods of the present invention the use of S-RA arch wires is followed by the use of C-RA arch wires. S-RA are Sectional RA arch wires. These wires have three distinct sections as described in more detail below. Generally, these sections include:

Anterior Section—This anterior section is primarily for alignment and intrusion of teeth. This section can cover all of the incisors, or some of the incisors along with a canine, or all anterior teeth. This section is vertically more occlusal than the tooth/teeth in the lateral section.

Lateral Sections—These sections may each have one or more teeth. Usually it is the canine but can also include a lateral incisor or the first premolar. This section of the wire bulges out laterally from the anterior section to accommodate the more labial or buccal position of the teeth in this region. This portion of the wire is not engaged on the bracket of these teeth. On the other hand, the teeth may be moved, most likely distal, occlusal and lingual, by bonding buttons and using elastics or power chain.

Posterior Sections—These sections are distal to the lateral sections and are used to align and expand the teeth in the posterior region.

Summary of Functions of S-RA: alignment and expansion of premolars and molars; alignment of incisors/anterior, without causing flaring; intrusion or extrusion of the anterior segment; and canine movement caused by bonded bracket/button, mostly in occluso-distal and lingual position (possibly opening space between incisor and premolar on lingual). Canine movement will depend on malocclusion. Upper canine will almost always need distal. Lower canine may need labial if there is need to increase intercanine width, distal or even mesial (in Cl II compensation).

Types of S-RA: RA arch with mesial wing (for more mesial position of the lateral section); RA arch with lateral wing; and RA arch with mesial wing on one side, lateral wing on other (can be flipped). Each of these come in different arch wires sizes—014, 016, 018, 16λ22, 17λ22, 14λ25, 20λ20, 19λ25. Each of these wire sizes can be in nickel titanium (NiTi) or stainless steel (SS). Each of these also come in 0° or 20° torque (wire can be flipped for negative torque) in the anterior section. Exception: When intercanine space is reduced with one or more proclined incisors and canines are in good position, stay off the incisors with RA arch. Use segmental alignment on incisors with different wire. Engage canine-molar on both sides if: intercanine width is reduced and canines are in good position in the arch; and incisors are proclined to start with, with or without crowding.

C-RA are consolidation RA arch wires. They are used after the S-RA have achieved their objectives. The process involves bonding the canine/teeth in the lateral section and engaging the C-RA arch wires accordingly. C-RA are used for: including teeth in lateral section in the arch; close extraction/other spaces; to continue to establish vertical relationships between upper and lower incisors; and finishing and detailing.

C-RA have: upper C-RA have occlusal step for 2-2; lower C-RA have gingival step for 3-3; each of these may have 0° or 20° torque for incisors; and each of these arch wires also come in 0° or 20° buccal root torque for posterior teeth.

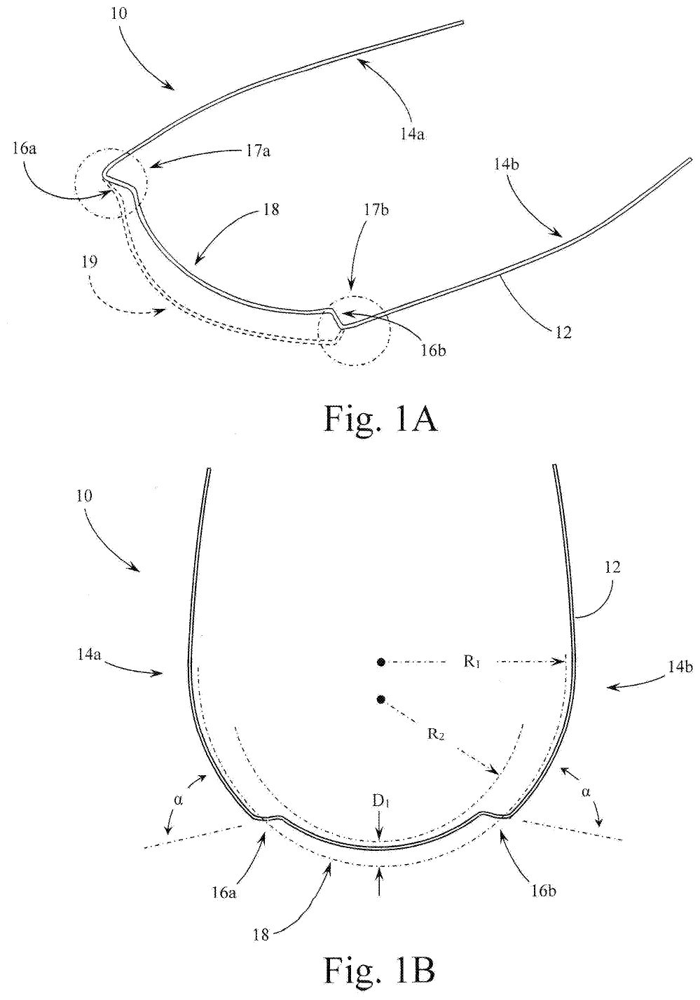

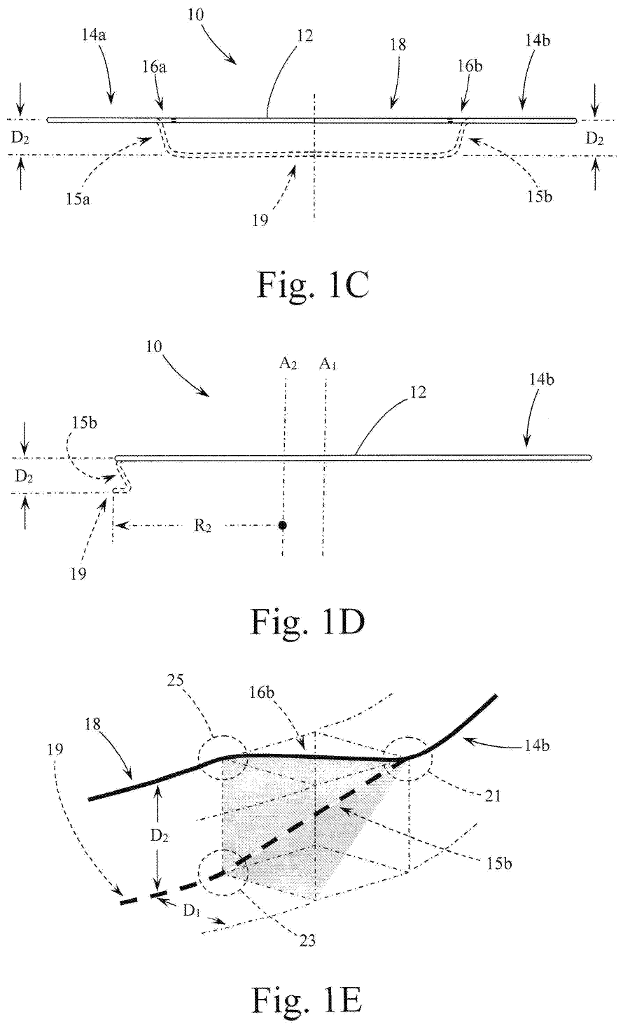

Reference is made to FIGS. 1A-1E for a detailed description of the basic structures of the arch wire of the present invention. FIG. 1A is a perspective view of a preferred embodiment of the basic orthodontic arch wire of the present invention showing the specifically defined regions of the arch wire. FIG. 1A shows a maxillary (upper) arch wire 10 structured from configured wire 12. The basic structure is made up of posterior sections 14a & 14b; lateral sections 16a & 16b; and in the basic embodiment, anterior section 18. The transition from posterior sections 14a & 14b to the anterior section 18 is made through lateral sections 16a & 16b through bends 17a & 17b. Bends 17a & 17b provide a radius step and an optional vertical step and establish the primary unique structures of the present invention.

Also shown in FIG. 1A is an optional compound embodiment with anterior section 19 shown in broken line form. This alternate embodiment for arch wire 10 is again made up of posterior sections 14a & 14b and lateral sections 16a & 16b but includes an additional angle within bends 17a & 17b. In this case, the transition from posterior sections 14a & 14b to the anterior section 19 is still made through lateral sections 16a & 16b through bends 17a & 17b. In addition to the standard radius step, bends 17a & 17b are preferably compound bends and include a vertical step that places anterior section 19 in a plane lower (in the maxillary arch) than posterior sections 14a & 14b.

FIG. 1B is a top plan view of the preferred embodiment of the basic orthodontic arch wire shown in FIG. 1A showing the defined regions of the arch wire and the anterior section “radius step” element of the present invention. wire. As in FIG. 1A, maxillary (upper) arch wire 10 is structured from configured wire 12. The basic structure is made up of posterior sections 14a & 14b; lateral sections 16a & 16b; and anterior section 18. The transition from posterior sections 14a & 14b to the anterior section 18 is made through lateral sections 16a & 16b through bends as described above.

In this view of FIG. 1B, only the radius step in the bend region of the lateral sections 16a & 16b is shown. This region is referred to as having a “radius step” due to the inward step shown by the difference between the radius of posterior sections curve R₁ and the radius of anterior section curve R₂. At the front of the arch this difference (R₁−R₂) is the radius step distance D₁. This inward step is structured for the reasons described above and is established with angle of lateral section bend a (as measure in the horizontal plane).

FIG. 1C is a front elevational view of the preferred embodiment of the basic orthodontic arch wire shown in FIG. 1A showing the defined regions of the arch wire and the optional anterior section “vertical step” element of the present invention. FIG. 1C again shows a maxillary (upper) arch wire 10 structured from configured wire 12. The basic structure is made up of posterior sections 14a & 14b; lateral sections 16a & 16b; and in the basic embodiment, anterior section 18. The transition from posterior sections 14a & 14b to the anterior section 18 is made through lateral sections 16a & 16b and is made without departing from the horizontal plane established by the posterior sections 14a & 14b.

Also shown in FIG. 1C is the optional compound embodiment with anterior section 19 shown in broken line form. This alternate embodiment for arch wire 10 is made up of posterior sections 14a & 14b that here translate into lateral sections 15a & 15b that each include an additional angle within bends as shown. Therefore, in addition to the standard radius step (not visible in FIG. 1C) the compound bends shown include a vertical step that places anterior section 19 in a plane lower (in the maxillary arch) than posterior sections 14a & 14b. The vertical step distance is shown in FIG. 1C as vertical step distance D₂.

FIG. 1D is a side elevational view of the preferred embodiment of the basic orthodontic arch wire shown in FIG. 1A showing the defined regions of the arch wire and the optional anterior section “vertical step” element of the present invention. FIG. 1D again shows a maxillary (upper) arch wire 10 structured from configured wire 12. The basic structure is made up of posterior sections 14a & 14b (only 14b visible in FIG. 1D); lateral sections 16a & 16b (not visible in FIG. 1D); and in the basic embodiment, anterior section 18 (also not visible in FIG. 1D). The transition from posterior sections 14a & 14b to the anterior section 18 is made through lateral sections 16a & 16b which, because they are in the same plane and are directed inward, are not visible in this side view of FIG. 1D.

Also shown in FIG. 1D is the optional compound embodiment with anterior section 19 shown in broken line form. This alternate embodiment for arch wire 10 is made up of posterior sections 14a & 14b (only 14b visible in FIG. 1D) that here translate into lateral sections 15a & 15b (only 15b visible in FIG. 1D) that each include an additional angle within bends as shown. Therefore, in addition to the standard radius step (only partially visible in FIG. 1D) the compound bends shown include a vertical step that places anterior section 19 in a plane lower (in the maxillary arch) than posterior sections 14a & 14b. The vertical step distance is shown in FIG. 1D as vertical step distance D₂. The radius of anterior section curve R₂ is also shown in FIG. 1D being the distance from the axis of anterior sections curve A₂ as measured to the anterior section 19 as shown. The axis of posterior sections curve A₁ is offset from the axis of anterior sections curve A₂ as shown (and as generally represented by the radius step distance D₁ shown in FIG. 1B). The arch wire 10, while not a complete circle and not a perfect circle (constant radius), does still generally comprise circular arc sections structured to be positioned next to the arcs of teeth in the patient's mouth.

FIG. 1E is a three dimensional view of the bend of one of the lateral sections of the preferred embodiment of the basic orthodontic arch wire shown in FIG. 1A showing the anterior section “radius step” element and the optional anterior section “vertical step” element of the present invention. In FIG. 1E posterior section 14b is shown transitioning into lateral section (radius step only option) 16b through bend 21 in the horizontal plane. Lateral section (radius step only option) 16b then transitions into anterior section (radius step only option) 18 through bend 25 in the horizontal plane.

Also shown in FIG. 1E (in broken line format) is the combination radius step and vertical step option with posterior section 14b transitioning into lateral section (radius step and vertical step option) 15b through compound bend 21. Lateral section (radius step and vertical step option) 15b then transitions into anterior section (radius step and vertical step option) 19 through compound bend 23. Once again, the radius step distance D₁ is shown as an inward step in the horizontal plane and the vertical step distance D₂ is shown as a downward (in the maxillary wire) step in the vertical plane.

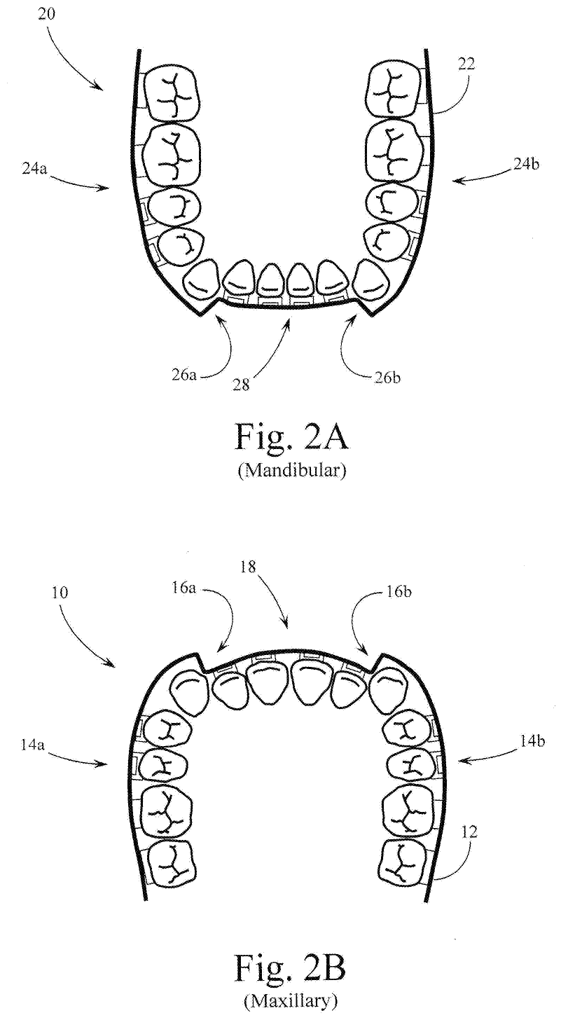

Reference is next made to FIGS. 2A & 2B for examples of a preferred embodiment of the basic orthodontic arch wire of the present invention initially positioned as they might be within a progressive orthodontic treatment plan. Those skilled in the art will recognize that individual patients will have varying degrees of alignment concerns and will therefore benefit from the use of the arch wires of the present invention at different stages in an overall alignment treatment program. Once again it is one goal of the present invention to facilitate the initial alignment of certain teeth without misaligning other teeth in the process.

FIG. 2A is a plan view (looking downward) of an example of the preferred embodiment of the basic orthodontic arch wire of the present invention shown in place on a mandibular (lower) set of teeth. In FIG. 2A, mandibular (lower) arch wire 20 is constructed of configured wire 22 with posterior sections 24a & 24b, transitioning to lateral sections 26a & 26b and transitioning anterior section 28. Important to note in FIG. 2A, in addition to the inward radial step formed by the lateral sections 26a & 26b, is the lack of engagement to bonded brackets/buttons on the canine teeth.

FIG. 2B is a plan view (looking upward) of an example of the preferred embodiment of the basic orthodontic arch wire of the present invention shown in place on a maxillary (upper) set of teeth. In FIG. 2B, maxillary (upper) arch wire 10 is constructed of configured wire 12 with posterior sections 14a & 14b, transitioning to lateral sections 16a & 16b and transitioning anterior section 18. As with the mandibular arch wire, it is important to note in FIG. 2B, in addition to the inward radial step formed by the lateral sections 16a & 16b, is the lack of engagement to bonded brackets/buttons on the canine teeth.

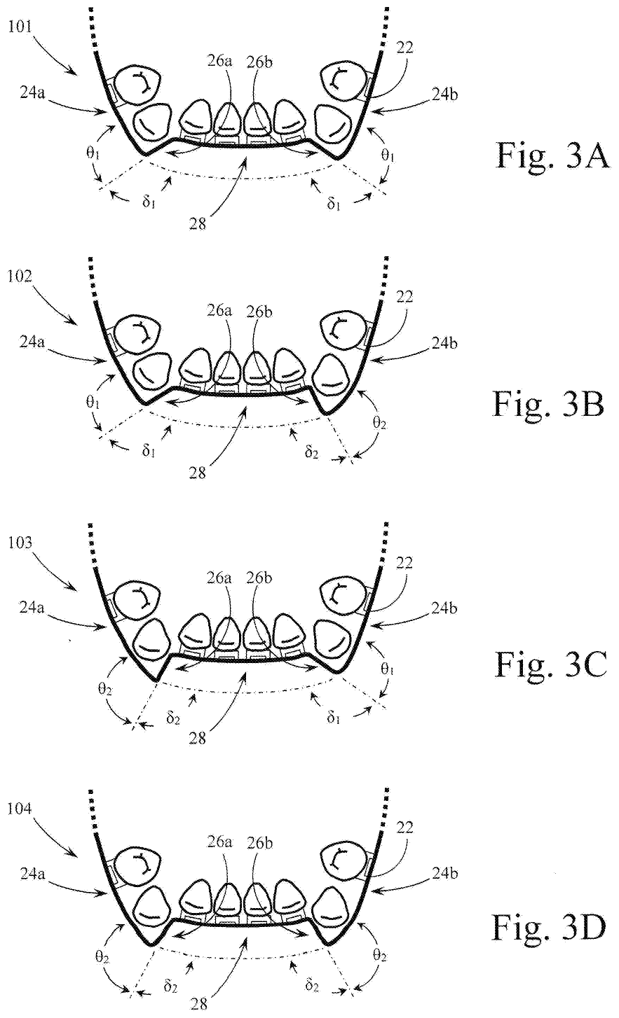

Reference is next made to FIGS. 3A-3D for detailed descriptions of the range of combinations of symmetrical and asymmetrical lateral wings possible with the elements of the present invention. All of the examples shown in FIGS. 3A-3D are presented on a mandibular (lower) set of teeth although one skilled in the art will recognize the same or similar application of the variations to the maxillary (upper) set of teeth. In FIGS. 3A-3D major portions of the posterior sections of the arch wires are omitted for clarity.

FIG. 3A is a top plan partial view (looking downward) of an example of the preferred embodiment of the orthodontic arch wire of the present invention shown in place on a mandibular (lower) set of teeth, configured with symmetrical lateral wings. In FIG. 3A, mandibular (lower) arch wire 101 is constructed of configured wire 22 with posterior sections 24a & 24b transitioning to lateral sections 26a & 26b which in turn transition to anterior section 28. In the symmetrical structure shown in FIG. 3A the arch wire has similar lateral wings where each wing has a first lateral wing bend angle (“inward” in the horizontal plane) θ₁ that is less “severe” or more specifically is an acute angle structured to accommodate a less severely misaligned canine (for example). The second lateral wing bend angle (“outward” in the horizontal plane) bi is therefore also less “severe” or more specifically is an obtuse angle transitioning the wire to the anterior section 28 curve.

FIG. 3B is a top plan partial view (looking downward) of an example of the preferred embodiment of the orthodontic arch wire of the present invention shown in place on a mandibular (lower) set of teeth, configured with asymmetrical wings (one lateral wing and one mesial wing). In FIG. 3B, mandibular (lower) arch wire 102 is similarly constructed of configured wire 22 with posterior sections 24a & 24b transitioning to lateral sections 26a & 26b which in turn transition to anterior section 28. In the asymmetrical structure shown in FIG. 3B, however, the arch wire has dissimilar wings where a first wing (the left side of the view of the mandibular set of teeth shown in FIG. 3B) has a first lateral wing bend angle (“inward” in the horizontal plane) θ₁ that is less “severe” or more specifically is an acute angle structured to accommodate a less severely misaligned canine (for example). The second lateral wing bend angle (“outward” in the horizontal plane) 81 is therefore also less “severe” or more specifically is an obtuse angle transitioning the wire to the anterior section 28 curve. The second wing (the right side of the view of the mandibular set of teeth shown in FIG. 3B) has a first mesial wing bend angle (“inward” in the horizontal plane) θ₂ that is more “severe” or more specifically is an obtuse angle structured to accommodate a more severely misaligned canine (for example). The second mesial wing bend angle (“outward” in the horizontal plane) δ₂ is therefore also more “severe” or more specifically is an acute angle transitioning the wire back to the anterior section 28 curve.

FIG. 3C is a top plan partial view (looking downward) of an example of the preferred embodiment of the orthodontic arch wire of the present invention shown in place on a mandibular (lower) set of teeth, configured with reversed asymmetrical wings (one lateral wing and one mesial wing). In FIG. 3C, mandibular (lower) arch wire 103 is similarly constructed of configured wire 22 with posterior sections 24a & 24b transitioning to lateral sections 26a & 26b which in turn transition to anterior section 28. In the asymmetrical structure shown in FIG. 3C, as in FIG. 3B, the arch wire has dissimilar wings, this time with a first wing (the left side of the view of the mandibular set of teeth shown in FIG. 3C) has a first mesial wing bend angle (“inward” in the horizontal plane) θ₂ that is more “severe” or more specifically is an obtuse angle structured to accommodate a more severely misaligned canine (for example). The second mesial wing bend angle (“outward” in the horizontal plane) δ₂ is therefore also more “severe” or more specifically is an acute angle transitioning the wire back to the anterior section 28 curve. The second wing (the right side of the view of the mandibular set of teeth shown in FIG. 3C) has a first lateral wing bend angle (“inward” in the horizontal plane) θ₁ that is less “severe” or more specifically is an acute angle structured to accommodate a less severely misaligned canine (for example). The second lateral wing bend angle (“outward” in the horizontal plane) δ₁ is therefore also less “severe” or more specifically is an obtuse angle transitioning the wire to the anterior section 28 curve.

FIG. 3D is a top plan partial view (looking downward) of an example of the preferred embodiment of the orthodontic arch wire of the present invention shown in place on a mandibular (lower) set of teeth, configured with symmetrical mesial wings. In FIG. 3D, mandibular (lower) arch wire 104 is constructed of configured wire 22 with posterior sections 24a & 24b transitioning to lateral sections 26a & 26b which in turn transition to anterior section 28. In the symmetrical structure shown in FIG. 3D the arch wire has similar mesial wings where each wing has a first mesial wing bend angle (“inward” in the horizontal plane) θ₂ that is more “severe” or more specifically is an obtuse angle structured to accommodate a more severely misaligned canine (for example). The second mesial wing bend angle (“outward” in the horizontal plane) δ₂ is therefore also more “severe” or more specifically is an acute angle transitioning the wire back to the anterior section 28 curve.

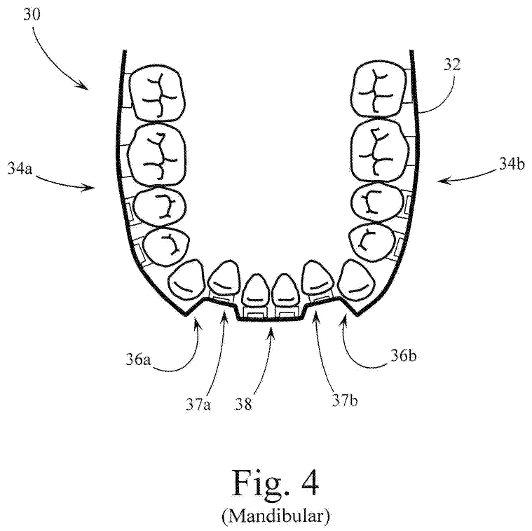

Reference is next made to FIG. 4 for a view of a customized use of the arch wire of the present invention that started with the basic arch wire shown in FIG. 2A (as an example). Where crowded incisors prevent a straight (smooth curve) anterior section, the arch wire may be fitted to each tooth as a custom wire. FIG. 4 is a plan view (looking downward) of an example of a customization of the preferred embodiment of the basic orthodontic arch wire of the present invention shown in place on a mandibular (lower) set of teeth. In FIG. 4, mandibular (lower) arch wire 30 is constructed of configured wire 32 with posterior sections 34a & 34b, transitioning to lateral sections 36a & 36b. In addition to the inward radial steps formed by the lateral sections 36a & 36b, outward radial steps are formed in the structure of anterior section 38. Incisor offset regions 37a & 37b are formed in anterior section 38 to accommodate the crowded incisors. This customized structure allows the orthodontist to initially focus on posterior expansion and creating space for the crowded incisors before subsequently trying to align the incisors. Other types of customizations departing off of the basic orthodontic arch wire of the present invention are anticipated.

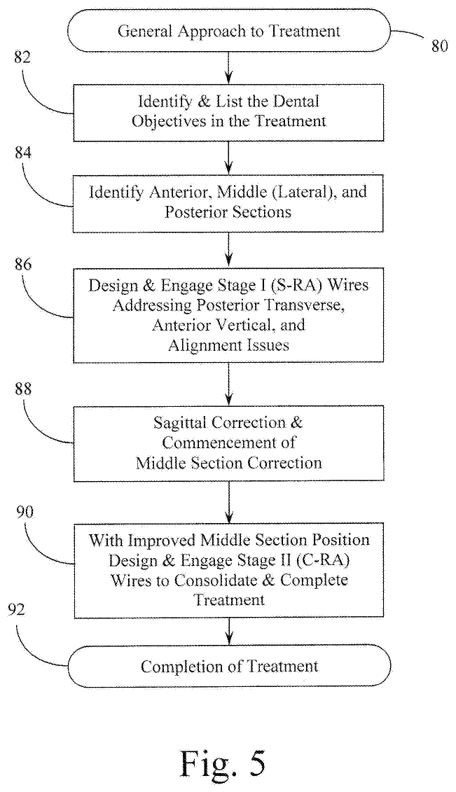

FIG. 5 is a flowchart of the basic method steps associated with the general approach to treatment implementing the system and methods of the present invention. As with all orthodontic treatments, the initial Step 80 involves setting forth a clear “map” of the alignment to be carried out and a sequential set of steps to carry out the treatment. Step 82 involves identifying and listing the dental objectives in the treatment. Step 84 begins the process of defining the “map” of the plan by identifying the anterior, middle (lateral), and posterior sections. The actual treatment begins at Step 86 with the design (selection and customization) and engagement of Stage I (S-RA) wires addressing posterior transverse, anterior vertical, and alignment issues.

Continuing with the Stage I wires, the process proceeds at Step 88 to carry out sagittal correction and commence middle section correction. The improved middle section position that results allows for Step 90 which involves the design and engagement of Stage II (C-RA) wires to consolidate and complete treatment. Further completion of treatment (as described below) may occur at final Step 92 in the general approach.

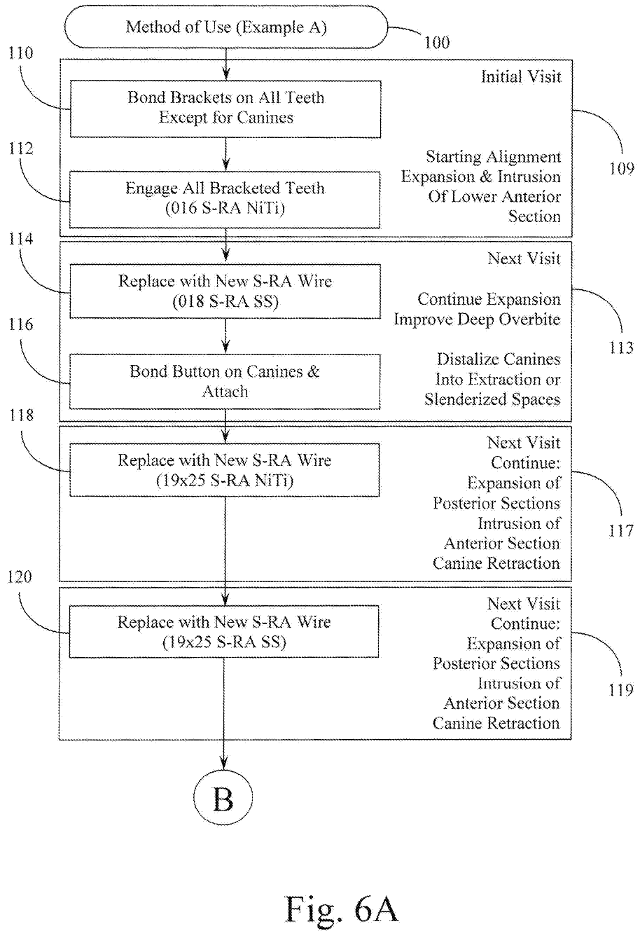

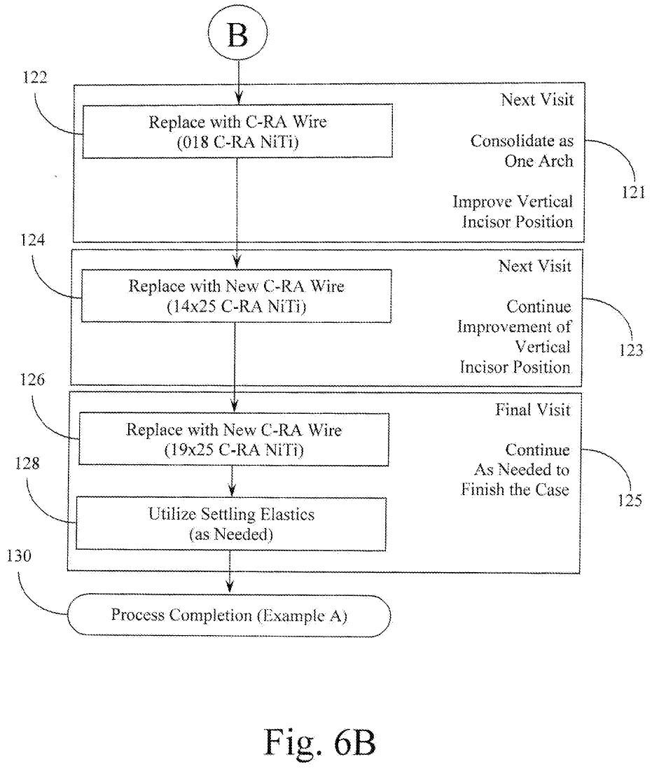

Reference is finally made to FIGS. 6A & 6B for a method flowchart providing an example (Example A) of step by step use of the process of the present invention in a case that has crowding in upper and lower arches, with blocked out canines. The process (initiated at method of use Step 100) involves the following steps:

At an initial visit (Step 109): The process of bonding brackets on all the teeth except for canines is carried out (Step 110).

At the same initial visit (Step 109): 016 S-RA NiTi (nickel titanium) wires are used to engage all the bracketed teeth, and to start alignment and expansion, as well as intrusion of lower anterior section, if needed (Step 112).

At the next visit (Step 113): 018 S-RA SS (stainless steel) replace the initial wires to continue expansion and improve deep overbite if needed (Step 114). Buttons are bonded on canines to distalize into extraction or slenderized spaces (Step 116).

At the next visit (Step 117): 19×25 NiTi replace the 018 S-RA SS to continue expansion of posterior sections, intrusion of anterior section and continue canine retraction (Step 118).

At the next visit (Step 119): 19×25 SS replace the 19×25 NiTi to continue expansion of posterior sections, intrusion of anterior section and continue canine retraction (Step 120).

The process of Example A continues (Connector B) with the steps shown in FIG. 6B as follows:

At the next visit (Step 121): 018 C-RA NiTi replace the 19×25 SS to consolidate as one arch, and to improve vertical incisor position (Step 122).

At the next visit (Step 123): 14×25 C-RA NiTi replace the 018 C-RA NiTi to continue improvement of vertical incisor position (Step 124).

At the next visit (Step 125): 19×25 NiTi C-RA replace the 14×25 NiTi (Step 126) with settling elastics as needed (Step 128) to finish the case. The process of Example A is completed at Step 130.

The above is an example of one clinical situation. As explained above, there can be many different variations, but the sequence will always be S-RA arch wires followed by C-RA arch wires.

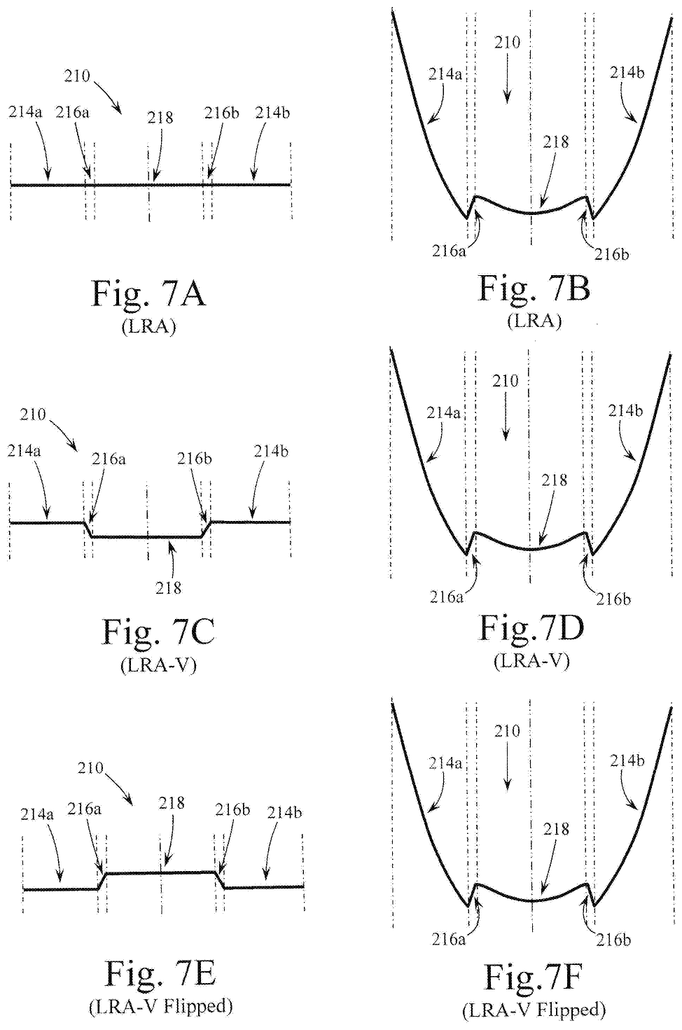

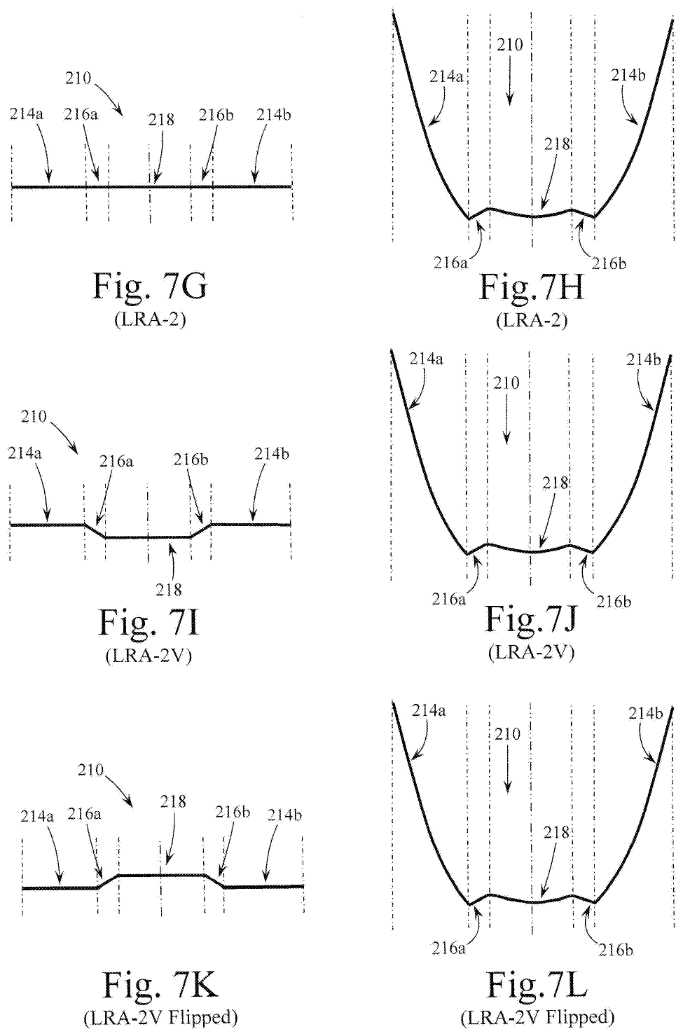

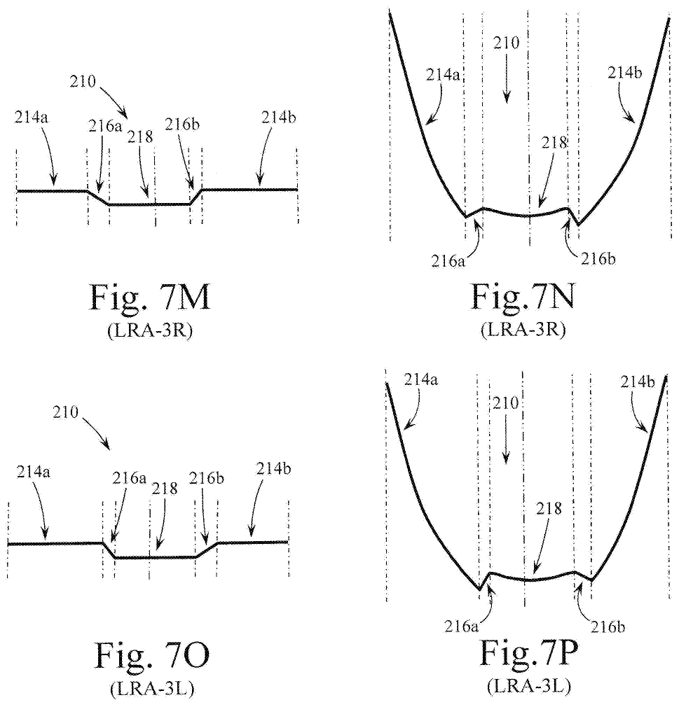

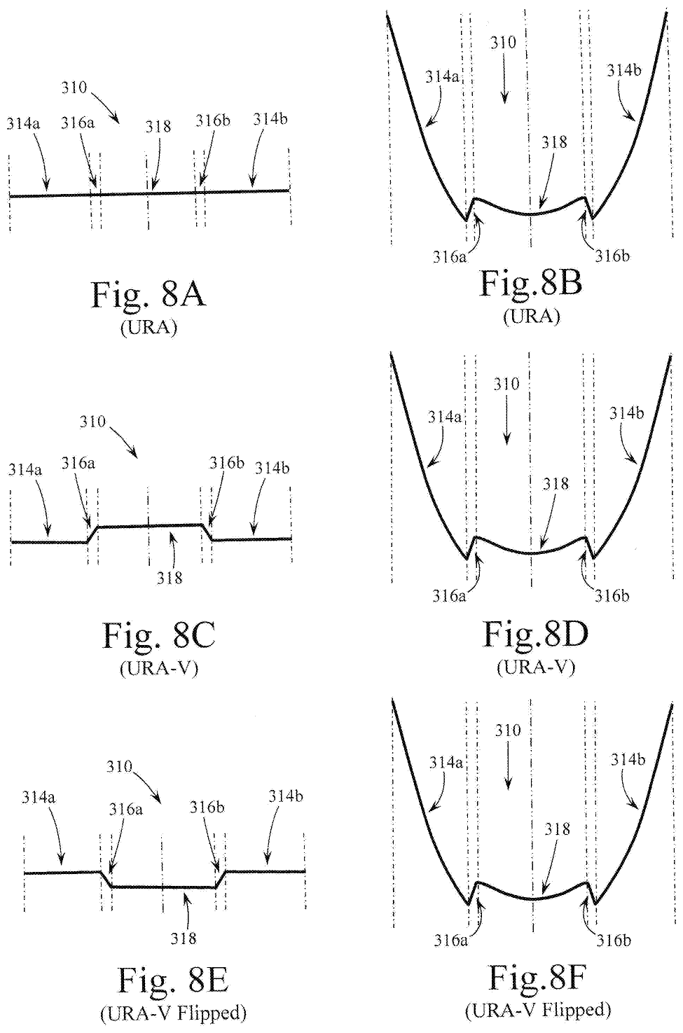

Reference is finally made to FIGS. 7A-7P and FIGS. 8A-8F are front profile and top plan views of summary examples of categories of lower and upper arches according to the present invention. For the various examples of lower arches shown, the following regions of arch wire 210 are indicated on either side of a centerline for the arch. The basic structure is made up of posterior sections 214a & 214b; lateral sections 216a & 216b; and in the basic embodiment, anterior section 218. The transition from posterior sections 214a & 214b to the anterior section 218 is made through lateral sections 216a & 216b.

FIGS. 7A & 7B represent front and top views of the classic RA arch with mesial bend between incisors and canines with no vertical bends. This example of a lower RA arch is identified as the LRA embodiment.

FIGS. 7C & 7D represent front and top views of the classic RA arch with intrusion for incisors (2-2) through a diagonal compound bend. This example of a lower RA arch is identified as the LRA-V embodiment.

FIGS. 7E & 7F represent front and top views of the classic RA arch shown in FIGS. 7C & 7D, flipped to be used for extrusion of L2-2 through the diagonal compound bend. This example of a lower RA arch is identified as the LRA-V Flipped embodiment.

FIGS. 7G & 7H represent front and top views of the classic RA arch with lateral bend between incisors and canines with no vertical bends. This example of a lower RA arch is identified as the LRA-2 embodiment.

FIGS. 7I & 7J represent front and top views of the classic RA arch with intrusion for anterior teeth (3-3) through two bends (labio-lingual bend mesial to canines and intrusion bend distal to canines). This example of a lower RA arch is identified as the LRA-2V embodiment.

FIGS. 7K & 7L represent front and top views of the classic RA arch shown in FIGS. 7I & 7J, flipped to be used for extrusion of L3-3. This example of a lower RA arch is identified as the LRA-2V Flipped embodiment.

FIGS. 7M-7L represent front and top views of the classic RA arch with vertical bends between incisors and canines on one side and canines and premolars on the other side. This configuration can be structured to the right or to the left. These examples of a lower RA arch are identified as the LRA-3R and LRA-3L embodiments.

For the various examples of upper arches shown in FIGS. 8A-8F, the following regions of arch wire 310 are indicated on either side of a centerline for the arch. The basic structure is made up of posterior sections 314a & 314b; lateral sections 316a & 316b; and in the basic embodiment, anterior section 318. The transition from posterior sections 314a & 314b to the anterior section 318 is made through lateral sections 316a & 316b.

FIGS. 8A & 8B represent front and top views of the classic RA arch with mesial bend between incisors and canines with no vertical bends. This example of an upper RA arch is identified as the URA embodiment.

FIGS. 8C & 8D represent front and top views of the classic RA arch with intrusion for incisors (2-2) through a diagonal compound bend. This example of an upper RA arch is identified as the URA-V embodiment.

FIGS. 8E & 8F represent front and top views of the classic RA arch shown in FIGS. 8C & 8D flipped in the manner shown. This example of an upper RA arch is identified as the URA-V Flipped embodiment.

Although the present invention has been described in association with a number of preferred embodiments, those skilled in the art will recognize other embodiments that still fall within the spirit and scope of the invention. As indicated above, the RA arches of the present invention may be provided in a number of basic configurations that may be used directly or customized as needed. The process of creating and/or customizing the RA arches of the present invention may be facilitated by the use of bending pliers structured with jaws that form predetermined bends according to the parameters of the devices and methods of the present invention. Preferred embodiments may therefore include pre-sized and pre-shaped RA arches and pre-sized wires that may be shaped with specific bending pliers to form the RA arches of the present invention.

I claim:

1. An orthodontic arch wire generally structured as a single curved length of wire, the arch wire comprising:
an anterior section, the anterior section comprising a region of the single curved length of wire at the center of the length of wire;
first and second posterior sections, the posterior sections comprising regions of the single curved length of wire at the terminal ends of the wire;
first and second lateral sections, the lateral sections comprising regions of the single curved length of wire between the posterior sections and the anterior section;
first and second inward radius step bends positioned at the transition between the posterior sections and the lateral sections; and
first and second outward curve return bends positioned at the transition between the lateral sections and the anterior section.

2. The orthodontic arch wire of claim 1 wherein the first and second inward radius step bends are each ≤90°, whereby the angle between each posterior section and the corresponding lateral section is >90°.

3. The orthodontic arch wire of claim 1 wherein the first and second inward radius step bends are each ≥90°, whereby the angle between each posterior section and the corresponding lateral section is <90°.

4. The orthodontic arch wire of claim 1 wherein one of said first and second inward radius step bends is ≤90°, whereby the angle between the associated posterior section and the corresponding lateral section is >90°, and the other of said first and second inward radius step bends is ≥90°, whereby the angle between the associated posterior section and the corresponding lateral section is <90°.

5. The orthodontic arch wire of claim 1 wherein the anterior section, the first and second posterior sections, and the first and second lateral sections all are within a common plane.

6. The orthodontic arch wire of claim 1 wherein said first and second inward radius step bends comprise compound bends establishing an additional vertical step associated with each inward radius bend, thereby placing the lateral sections and the anterior section outside the plane of the posterior sections.

7. The orthodontic arch wire of claim 1 wherein the anterior section is multi-level to accommodate varying degrees of incisor misalignment.

8. The orthodontic arch wire of claim 1 wherein the length of wire is constructed of wire material selected from the following group: nickel titanium (NiTi) and stainless steel (SS).

9. The orthodontic arch wire of claim 1 wherein the length of wire is constructed of wire sized as selected from the following group: 014, 016, 018, 16×22, 17×22, 14×25, 20×20, 19×25.

10. The orthodontic arch wire of claim 1 wherein the length of wire is constructed of wire having 0° or 20° torque in the anterior section.

11. A method for orthodontic treatment, the method comprising the steps of:
identifying anterior, middle (lateral), and posterior sections of the teeth to undergo treatment;
providing a first set of arch wires having distinctly defined posterior, lateral, and anterior sections;
engaging at least one of the first set of arch wires to address posterior transverse, anterior vertical, and alignment issues;
engaging at least one of the first set of arch wires to provide sagittal correction and commencement of middle section correction;
upon improved middle section position, providing a second set of arch wires having distinctly defined posterior, lateral, and anterior sections; and
engaging at least one of the second set of arch wires to consolidate and complete treatment.

12. The method of claim 11 wherein the step of engaging at least one of the first set of arch wires to address posterior transverse, anterior vertical, and alignment issues comprises attachment to bonded brackets/buttons on the posterior section teeth and the anterior section teeth but omits attachment on the lateral section teeth.

13. The method of claim 11 wherein the step of engaging at least one of the second set of arch wires to consolidate and complete treatment comprises attachment to bonded brackets/buttons on the posterior section teeth, the anterior section teeth, and the lateral section teeth.

14. The method of claim 11 further comprising the step of applying settling elastics to complete treatment.

15. The method of claim 11 further comprising the step of customizing the anterior section of the arch wire to accommodate varying levels of misalignment in the anterior section teeth.

16. The method of claim 11 wherein the teeth to undergo treatment are mandibular teeth.

17. The method of claim 11 wherein the teeth to undergo treatment are maxillary teeth.
